(19) United States
(12) Patent Application Publication
(10) Pub. No.: US 2013/0150025 A1
(43) Pub. Date: Jun. 13, 2013

(54) DOCKING DEVICE WITH TELEPHONE EXCHANGE FUNCTION

(71) Applicant: HSIAO-CHUNG CHEN, TAIPEI (TW)

(72) Inventor: HSIAO-CHUNG CHEN, TAIPEI (TW)

(73) Assignees: LITE-ON TECHNOLOGY CORP., TAIPEI (TW); SILITEK ELECTRONIC (GUANGZHOU) CO., LTD., GUANGZHOU (CN)

(21) Appl. No.: 13/554,060

(22) Filed: Jul. 20, 2012

(30) Foreign Application Priority Data
Dec. 8, 2011 (CN) 201110414979.3

(51) Int. Cl. H04W 4/00

(52) U.S. Cl. 455/426.1

(57) ABSTRACT

A docking device with telephone exchange function includes a docking base for placement of and for coupling with a mobile phone, a telephone communication interface for coupling with a landline telephone set and to receive a dialing signal therefrom, a processor to receive an incoming call signal from the mobile phone, and an exchange module converting the incoming call signal into an analog incoming call signal to be outputted to the landline telephone set such that an incoming call may be answered. The exchange module further converts the dialing signal into a digital dialing signal and the processor converts the digital dialing signal into a converted digital dialing signal compatible in format with and to be outputted to the mobile phone for making a mobile phone call.

### CROSS-REFERENCE TO RELATED APPLICATION

This application claims priority of Chinese Patent Application No. 201110414979.3, filed on Dec. 8, 2011.

### BACKGROUND OF THE INVENTION

1. Field of the Invention

The present invention relates to a docking device to be used with an electronic device, more particularly to docking device with a telephone exchange function.

2. Description of the Related Art

A conventional docking device to be used with a mobile phone is primarily adapted for charging the mobile phone and for playing sound tracks stored in the mobile phone. Moreover, since most people own mobile phones, a lot of them do not or need not install a landline telephone set at their dwellings, and only use their own mobile phones as a replacement for the traditional wired/wireless landline telephone sets.

However, once a mobile phone is used for communication in vicinity of a user's ear for a period of time, electromagnetic waves from the mobile phone might have adverse influences upon the user's brain and body. Therefore, when the user gets home and places the mobile phone on a docking device for battery charging and music playback, the adverse influences resulting from the electromagnetic waves from the mobile phone upon the user may be lessened if the user is able to make a mobile phone call via a landline telephone set that is electrically coupled with the docking device, or is able to answer an incoming call of the mobile phone via the landline telephone set.

### SUMMARY OF THE INVENTION

An object of the present invention is to provide a docking device with telephone exchange function capable of alleviating the above drawbacks of the prior art.

Accordingly, the docking device of this invention is to be used with a mobile phone and a landline telephone set, and comprises a docking base, a telephone communication interface, a processor, and an exchange module.

The docking base is for placement of the mobile phone and for electrically coupling with the mobile phone. The telephone communication interface is for electrically coupling with the landline telephone set and is operable to receive a dialing signal therefrom. The processor is electrically coupled to the docking base and is operable to receive, via the docking base, an incoming call signal outputted from the mobile phone. The exchange module is electrically coupled with the processor for receiving the incoming call signal, and with the telephone communication interface for receiving the dialing signal. The exchange module is configured to convert the incoming call signal into an analog incoming call signal which is to be outputted to the landline telephone set via the telephone communication interface such that an incoming call associated with the incoming call signal maybe answered via the landline telephone set. The exchange module is further configured to convert the dialing signal into a digital dialing signal which is transmitted to the processor, and the processor is configured to convert the digital dialing signal into a converted digital dialing signal which is compatible in format with the mobile phone and which is to be outputted to the mobile phone via the docking base for making a mobile phone call according to the converted digital dialing signal.

Preferably, the docking device further comprises a landline connection interface which is electrically coupled with the exchange module, and an input interface which is electrically coupled with the processor. The landline connection interface is adapted to be electrically coupled with a wired telephone network. The processor is configured to control, according to a setting command inputted via the input interface, the exchange module to transmit the dialing signal via the landline connection interface to the wired telephone network for making a landline telephone call. The processor is further configured to receive a landline incoming call signal via the exchange module and the landline connection interface from the wired telephone network, and to output the landline incoming call signal via the exchange module and the telephone communication interface to the landline telephone set.

Preferably, when the processor receives the landline incoming call signal from the wired telephone network while a mobile phone call is being made or being answered, the processor is configured to output a busy tone signal via the exchange module and the landline connection interface to the wired telephone network for informing a calling party associated with the landline incoming call signal. On the other hand, when the processor receives the incoming call signal outputted from the mobile phone while a landline telephone call is being made or being answered, the processor is configured to output a busy tone signal via the docking base to the mobile phone for informing a calling party associated with the incoming call signal.

Preferably, when the processor determines that the digital dialing signal does not include information related to an area code, the processor is configured to automatically add the information related to the area code to the digital dialing signal prior to outputting the converted digital dialing signal to the mobile phone via the docking base.

Preferably, the exchange module includes a modem which is utilized to convert the incoming call signal into the analog incoming call signal, and to convert the dialing signal into the digital dialing signal.

Preferably, the docking device further comprises a multimedia player module which is electrically coupled with the processor, and a multimedia output module which is electrically coupled with the multimedia player module. The processor is configured to access a multimedia file stored in the mobile phone via the docking base, and to transmit the multimedia file to the multimedia player module for decoding and decompression and for subsequent playback via the multimedia output module.

Preferably, the docking device further comprises a wireless communication module which is electrically coupled with the processor. The processor being configured to transmit the multimedia file, which is accessed from the mobile phone via the docking base, to a remote multimedia output device via the wireless communication module.

Preferably, the wireless communication module is one of a WiFi AirPlay module which supports the WiFi AirPlay protocol and a WiFi Digital Living Network Alliance (DLNA) module which support the WiFi DLNA guidelines.

Effects of the present invention reside in that the docking device is utilized as a communication interface between the mobile phone and the landline telephone set, and is able to convert, by virtue of the modem of the exchange module and the processor, the dialing signal which is inputted via the landline telephone set by the user into the converted digital dialing signal which is compatible in format with the mobile phone for making a mobile phone call according to the converted digital dialing signal. In this way, the user may be kept away from electromagnetic waves from the mobile phone when making a mobile phone call via the landline telephone set and the docking device. Moreover, the docking device is able to access a multimedia file stored in the mobile phone for subsequent playback via the multimedia output module.

### BRIEF DESCRIPTION OF THE DRAWINGS

Other features and advantages of the present invention will become apparent in the following detailed description of the embodiment with reference to the accompanying drawings, of which:

FIG. 1 is a perspective view of a preferred embodiment of a docking device with telephone exchange function, according to the present invention, illustrating the docking device to be used with a mobile phone and a landline telephone set; and

FIG. 2 is a block diagram of the preferred embodiment of the docking device.

### DETAILED DESCRIPTION OF THE EMBODIMENT

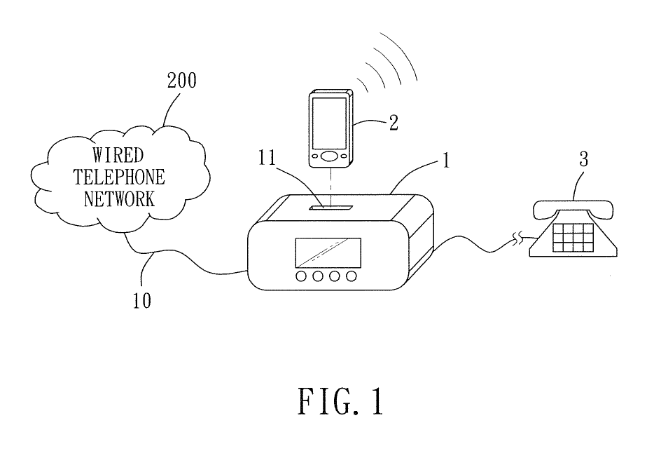

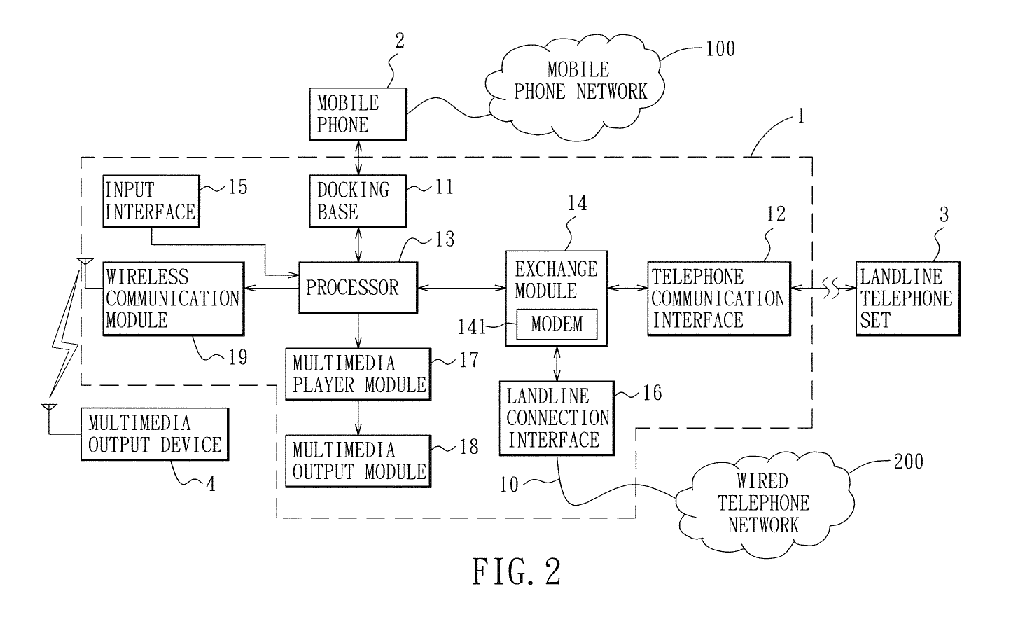

Referring to FIG. 1 and FIG. 2, a preferred embodiment of a docking device with telephone exchange function (named docking device hereinafter for the sake of brevity) according to the present invention is illustrated. The docking device 1 of the preferred embodiment is to be used with a mobile phone 2 (such as a current iPhone, an Android phone or an ordinary phone), and a landline telephone set 3, and the mobile phone 2 is connected to a mobile phone network 100, so that a user may make a mobile phone call with the mobile phone 2 via the landline telephone set 3 and the docking device 1. The docking device 1 comprises a docking base 11, a telephone communication interface 12, a processor 13, and an exchange module 14.

The docking base 11 is a recess formed in a top surface of the docking device 1 for placement of the mobile phone 2 and for electrically coupling with the mobile phone 2.

The telephone communication interface 12 is for electrically coupling with the landline telephone set 3 and is operable to receive a dialing signal therefrom.

The processor 13 is electrically coupled to the docking base 11 and is operable to receive, via the docking base 11, an incoming call signal outputted from the mobile phone 2.

The exchange module 14 is electrically coupled with the processor 13 for receiving the incoming call signal, and with the telephone communication interface 12 for receiving the dialing signal. The exchange module 14 includes a modem (modulator-demodulator) 141. The modem 141 is utilized to convert the incoming call signal received by the processor 13 into an analog incoming call signal which is to be outputted to the landline telephone set 3 via the telephone communication interface 12 such that an incoming call associated with the incoming call signal may be answered via the landline telephone set 3. Further, the modem 141 is utilized to convert the dialing signal received from the telephone communication interface 12 into a digital dialing signal which is transmitted to the processor 13. The processor 13 is configured to convert the digital dialing signal into a converted digital dialing signal which is compatible in format with the mobile phone 2 and which is to be outputted to the mobile phone 2 via the docking base 11 for making a mobile phone call according to the converted digital dialing signal via the mobile phone network 100.

In addition, an area code is necessary when dialing a landline telephone number from the mobile phone 2, such as New Jersey 201, Washington, D.C. 202, California 209, etc. However, when dialing the landline telephone number with the landline telephone set 3, the area code is usually omitted in a condition that the area code indicates the same geographical area at which the landline telephone set 3 is installed. Therefore, the docking device 1 further comprises an input interface 15, such as a physical key pad or a touch key pad, which is electrically coupled with the processor 13 for setting of the area code that indicates the geographical area where the docking device 1 is located. For example, when the docking device 1 is located at New Jersey, an area code of 201 is inputted via the input interface 15 and is stored in the processor 13. In this manner, the processor unit 13 is configured to determine whether the digital dialing signal includes information related to an area code upon receipt of the digital dialing signal. That is, to determine whether a landline telephone number incorporated in the information of the digital dialing signal is preceded by any area code. If negative, it means that the user intends to dial the landline telephone number which belongs to the same geographical area where the docking device 1 and the user are located, and the processor 13 is configured to automatically add the information related to the area code of 201 to the digital dialing signal prior to outputting the converted digital dialing signal to the mobile phone 2 via the docking base 11.

Hence, the user may place the mobile phone 2 on the docking device 1, may make a mobile phone call with the mobile phone 2 via the docking device 1 by operating the landline telephone set 3, and may answer an incoming call of the mobile phone 2 via the docking device 1 by using the landline telephone set 3. In this way, the user need not come into direct contact with the mobile phone 2 when making or answering a mobile phone call at home so as to lessen the adverse influences resulting from electromagnetic waves from the mobile phone 2.

Moreover, in this embodiment, the docking device 1 further comprises a landline connection interface 16 which is electrically coupled with the exchange module 14. When the user applies for a landline telephone number from a telephone company, the landline connection interface 16 is adapted to be electrically coupled with a wired telephone network 200 (or a fixed line, such as the PSTN) via a telephone line 10. In this situation, the user may set the exchange module 14 of the docking device 1 through the input interface 15 so as to select one of the mobile phone 2 and the landline telephone 3 for making a call. That is, the processor 13 is configured to control, according to a setting command (such as a landline telephone use command) inputted via the input interface 15, the exchange module 14 to transmit the dialing signal, which is received from the telephone communication interface 12, via the landline connection interface 16 and the telephone line 10 to the wired telephone network 200 for making a landline telephone call. The processor 13 is further configured to receive a landline incoming call signal via the exchange module 14 and the landline connection interface 16 from the wired telephone network 200, and to output the landline incoming call signal via the exchange module 14 and the telephone communication interface 12 to the landline telephone set 3.

Alternatively, when the setting command inputted via the input interface 15 is a mobile phone use command, the docking device 1 operates according to the aforementioned procedures. That is, the modem 141 of the exchange module 14 converts the dialing signal into a digital dialing signal, and the processor 13 converts the digital dialing signal into a converted digital dialing signal which is compatible in format with the mobile phone 2 (such as adding the information related to the area code) and which is to be outputted to the mobile phone 2 for making a mobile phone call according to the converted digital dialing signal via the mobile phone network 100.

Furthermore, when the processor 13 receives the landline incoming call signal from the wired telephone network 200 while a mobile phone call is being made or being answered, such as receiving the landline incoming call signal from the wired telephone network 200 immediately subsequent to receipt of the incoming call signal from the mobile phone 2, the processor 13 is configured to output a busy tone signal via the exchange module 14 and the landline connection interface 16 to the wired telephone network 200 for informing a calling party (not shown) associated with the landline incoming call signal. On the other hand, when the processor 13 receives the incoming call signal outputted from the mobile phone 2 while a landline telephone call is being made or being answered, such as receiving the incoming call signal from the mobile phone 2 immediately subsequent to receipt of the landline telephone call signal from the wired telephone network 200, the processor 13 is configured to output a busy tone signal via the docking base 11 to the mobile phone 2 (or enable the mobile phone 2 to generate a busy tone) for informing a calling party (not shown) associated with the incoming call signal.

In this embodiment, the docking device 1 further comprises a multimedia player module 17 which is electrically coupled with the processor 13, and a multimedia output module 18 which is electrically coupled with the multimedia player module 17. The multimedia output module 18 includes a speaker and/or a display. The processor 13 is configured to access, according to an operation command inputted via the input interface 15 by the user, a multimedia file stored in the mobile phone 2 via the docking base 11, such as an MP3 sound track file or an MP4 video file, and to transmit the multimedia file to the multimedia player module 17 for decoding and decompression and for subsequent playback via the multimedia output module 18.

Additionally, the docking device 1 of the preferred embodiment further comprises a wireless communication module 19 which is electrically coupled with the processor 13. The wireless communication module 19 is one of a WiFi AirPlay module which supports the WiFi AirPlay protocol and a WiFi Digital Living Network Alliance (DLNA) module which supports the WiFi DLNA guidelines. The processor 13 is configured to transmit the multimedia file, which is accessed from the mobile phone 2 via the docking base 11, to a remote multimedia output device 4 which supports one of the WiFi AirPlay protocol and the WiFi DLNA guidelines via the wireless communication module 19. The multimedia output device 4 includes at least a speaker and/or a display, such as a digital audio system or a digital television, for playback of the multimedia file stored in the mobile phone 2.

To sum up, in the a forementioned preferred embodiment, the docking device 1 is utilized as a communication interface between the mobile phone 2 and the landline telephone set 3, and the dialing signal inputted via the landline telephone set 3 by the user is converted, by virtue of the modem 141 of the exchange module 14 and the processor 13, into the converted digital dialing signal which is compatible in format with the mobile phone 2 and which is to be outputted to the mobile phone 2 for making a mobile phone call according to the converted digital dialing signal. In this way, the user may be kept at a distance from the mobile phone 2 when making or answering a mobile phone call at home without being concerned about the adverse influences resulting from electromagnetic waves from the mobile phone 2. In addition, the docking device 1 is further adapted to access the multimedia file stored in the mobile phone 2 and to perform a multimedia playback operation.

While the present invention has been described in connection with what is considered the most practical embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A docking device with telephone exchange function, the docking device to be used with a mobile phone and a landline telephone set, comprising:
a docking base for placement of the mobile phone and for electrically coupling with the mobile phone;
a telephone communication interface for electrically coupling with the landline telephone set and operable to receive a dialing signal therefrom;
a processor electrically coupled to the docking base and operable to receive, via the docking base, an incoming call signal outputted from the mobile phone; and
an exchange module electrically coupled with the processor for receiving the incoming call signal, and with the telephone communication interface for receiving the dialing signal,
wherein the exchange module is configured to convert the incoming call signal into an analog incoming call signal which is to be outputted to the landline telephone set via the telephone communication interface such that an incoming call associated with the incoming call signal may be answered via the landline telephone set,
wherein the exchange module is further configured to convert the dialing signal into a digital dialing signal which is transmitted to the processor and the processor is configured to convert the digital dialing signal into a converted digital dialing signal which is compatible in format with the mobile phone and which is to be outputted to the mobile phone via the docking base for making a mobile phone call according to the converted digital dialing signal.

2. The docking device as claimed in claim 1, further comprising a landline connection interface which is electrically coupled with the exchange module, and an input interface which is electrically coupled with the processor, the landline connection interface being adapted to be electrically coupled with a wired telephone network,
wherein the processor is configured to control, according to a setting command inputted via the input interface, the exchange module to transmit the dialing signal via the landline connection interface to the wired telephone network for making a landline telephone call,
wherein the processor is further configured to receive a landline incoming call signal via the exchange module and the landline connection interface from the wired telephone network, and to output the landline incoming call signal via the exchange module and the telephone communication interface to the landline telephone set.

3. The docking device as claimed in claim 2, wherein the exchange module includes a modem which is utilized to convert the incoming call signal into the analog incoming call signal, and to convert the dialing signal into the digital dialing signal.

4. The docking device as claimed in claim 2, wherein:
when the processor receives the landline incoming call signal from the wired telephone network while a mobile phone call is being made or being answered, the processor is configured to output a busy tone signal via the exchange module and the landline connection interface to the wired telephone network for informing a calling party associated with the landline incoming call signal; and
when the processor receives the incoming call signal outputted from the mobile phone while a landline telephone call is being made or being answered, the processor is configured to output a busy tone signal via the docking base to the mobile phone for informing a calling party associated with the incoming call signal.

5. The docking device as claimed in claim 4, wherein the exchange module includes a modem which is utilized to convert the incoming call signal into the analog incoming call signal, and to convert the dialing signal into the digital dialing signal.

6. The docking device as claimed in claim 1, wherein when the processor determines that the digital dialing signal does not include information related to an area code, the processor is configured to automatically add the information related to the area code to the digital dialing signal prior to outputting the converted digital dialing signal to the mobile phone via the docking base.

7. The docking device as claimed in claim 6, wherein the exchange module includes a modem which is utilized to convert the incoming call signal into the analog incoming call signal, and to convert the dialing signal into the digital dialing signal.

8. The docking device as claimed in claim 1, wherein the exchange module includes a modem which is utilized to convert the incoming call signal into the analog incoming call signal, and to convert the dialing signal into the digital dialing signal.

9. The docking device as claimed in claim 8, further comprising a multimedia player module which is electrically coupled with the processor, and a multimedia output module which is electrically coupled with the multimedia player module, the processor being configured to access a multimedia file stored in the mobile phone via the docking base, and to transmit the multimedia file to the multimedia player module for decoding and decompression and for subsequent playback via the multimedia output module.

10. The docking device as claimed in claim 9, further comprising a wireless communication module which is electrically coupled with the processor, the processor being configured to transmit the multimedia file, which is accessed from the mobile phone via the docking base, to a remote multimedia output device via the wireless communication module.

11. The docking device as claimed in claim 10, wherein the wireless communication module is one of a WiFi AirPlay module which supports the WiFi AirPlay protocol and a WiFi Digital Living Network Alliance (DLNA) module which supports the WiFi DLNA guidelines.
